(19) United States
(12) Patent Application Publication
(10) Pub. No.: US 2023/0062235 A1
(43) Pub. Date: Mar. 2, 2023

(54) PROCEDURE TO GENERATE A CONTROL VECTOR AND ADEX SYSTEM APPLYING THE SAME

(71) Applicant: ADAPTIVE PREDICTIVE EXPERT CONTROL ADEX SA, Madrid (ES)

(72) Inventors: Emilio Antón, Soria (ES); Isaias Martín, MADRID (ES); Juan Martín, MADRID (ES)

(21) Appl. No.: 17/797,929

(22) PCT Filed: Feb. 1, 2021
(86) PCT No.: PCT/ES2021/070077

§ 371 Date: Aug. 5, 2022

(30) Foreign Application Priority Data
Feb. 6, 2021 (ES) P 202030096

(51) Int. Cl. G05B 13/04

(52) U.S. Cl. CPC G05B 13/048; G05B 13/041

(57) ABSTRACT

Adaptive predictive expert control procedure or system, called ADEX, that implements a control strategy in which an adaptive predictive expert controller, called ADEX controller, uses in its adaptive predictive domains a predictive adaptive model that dynamically relates the output of the process to be controlled with an integral function of the control signal that is applied to the process, instead of dynamically relating said process output with the signal that is applied to the process as conventional ADEX controllers of the prior art do. In this way, the output of said ADEX controller is an integral function of the control signal. From this integral function said control strategy uses a differential operator to calculate the real control action that is applied to the process.

Procedure to generate a control vector and ADEX system that applies it.

The invention refers to an adaptive predictive expert control system, called ADEX system, which uses an integral function of the control signal applied to the process to control output variables of monovariable or multivariable processes, where the process parameters are known or unknown. and constant or variable in time. The ADEX system of the present invention implements a control strategy in which an expert predictive adaptive controller, called ADEX controller, uses in its predictive adaptive domains a predictive adaptive model that dynamically relates the output of the process to be controlled with an integral function of the control signal that is applied to the process, instead of dynamically relating said process output with the signal that is applied to the process as conventional ADEX controllers of the prior art do. In this way, the output of said ADEX controller is an integral function of the control signal. From this integral function said control strategy uses a differential operator to calculate the real control action that is applied to the process.

### STATE OF THE ART

The invention is part of the area of digital control systems that use a computer that contains a program that is periodically executed in a plurality of control instants k, to produce a control signal that is applied at each of said instants k to the apparatus that carries out the process to control the evolution of its output variables. The invention, as a procedure, defines the sequence of operations determined by said program and, as a system, defines the sets of instructions that are executed in a coherent way with the support of said computer to calculate and apply the control signal in question to the apparatus that performs the process.

The book “ADEX Optimized Adaptive Systems and Controllers: From Research to Industrial Practice”, published by Springer publisher in 2015, describes the methodology, stability theory and various applications of Expert Adaptive Predictive controllers, which were introduced, defined and described in detail in U.S. Pat. No. 6,662,058 B1. These controllers represent a methodological extension of the adaptive predictive controllers previously defined in U.S. Pat. Nos. 4,197,576 and 4,358,822. This book names these controllers ADEX controllers and this document will use the same ADEX controller nomenclature for the controllers described in the previously mentioned US patents for simplicity.

As described in U.S. Pat. No. 6,662,058 B1, an ADEX controller in its domains of operation called Adaptive Predictive, adjusts at each control instant the parameters of a predictive adaptive model (AP) that identifies a relationship dynamics between the process variables and a control signal to apply to the process; and uses said AP model to calculate the control signal that must be applied to the process so that the prediction of the output variable of the process to be controlled is equal to a desired value for said output variable of the process. ADEX controllers can also include so-called expert domains of operation, in which the control signal is generated by rules that mimic the performance of manual control performed by a human operator.

The adaptive predictive controllers described in U.S. Pat. Nos. 4,197,576 and 4,358,822 can be defined as ADEX controllers that operate only in a single adaptive predictive domain. Consequently, the reference to ADEX controllers that follows in this document also includes the set of adaptive predictive controllers defined in said American patents, since the present invention concerns only the application of ADEX controllers in their adaptive predictive domains.

Also, said book clearly distinguishes between ADEX controllers and ADEX systems as follows: while an ADEX controller has been defined in U.S. Pat. No. 6,662,058 B1 and is used to control output variables of a process, an ADEX system is defined by a control strategy for a process in which ADEX controllers are used to achieve better overall performance in the operation of the process. In this case, an ADEX system will be innovative if the control strategy that defines it is innovative.

The invention is related to an ADEX system to control monovariable or multivariable process output variables through the use of a control strategy that generates an integral function of the control signal that is applied to the process at different control instants and uses this integral function in such a way that the control performance obtained for said output variables improves significantly, in a range of small control periods with respect to the dynamics of the process, the performance that would be obtained by the direct application of a conventional ADEX controller, belonging to the previously patented state of the art, in the same application context.

Generally, the time elapsed between two consecutive control instants in the operation of a controller or a control system is called the control period. In the application of ADEX controllers, the control period is generally chosen taking into account the dynamics of the process. Thus, if the process has slow dynamics, the control period will be chosen for this type of process longer than that which would be chosen for a process with faster dynamics. In general, the control period is chosen equal to a percentage of the so-called natural response time of the process, that is, the time it takes for the process to go from one state of equilibrium to another in response to an input to the step process. A reasonable choice of control period could generally be in the range of one-tenth to one-twentieth of the natural response time of the process. The control period is often determined by practical considerations, such as the frequency of disturbances acting on the process and the effect of which has to be compensated for by the control signal.

This kind of ADEX system is useful in a wide variety of areas where process control is important for the economic performance of plants, such as the cement or energy area and, in general, in industry. Examples of processes in which this ADEX system can be applied advantageously are cement mills, where the fineness of the ground product is controlled by the Clinker flow input, or coal-fired power plants, where the generated power is controlled by means of the coal flow inlet. It is often difficult to identify a dynamic relationship between the output variables to be controlled in this type of process and the inputs to the process or control signals, which explains the low control performance generally obtained in this context by control techniques such as that of Advanced Model-Based Controllers, where the model represents the result of such identification.

It is known that Advanced Model-Based Controllers use a process input/output (I/O) relationship or process model to predict the evolution of the process output variables. The reliability of this prediction depends on the value of the parameters of the process model, called the predictive model. Some solutions require predetermining the value of these model parameters before the controller in question starts its automatic control operation; this is the case of the so-called Model-Based Predictive Controllers. Other so-called adaptive control solutions update a model of the process in real time through an adaptation mechanism, in such a way that changes that may occur in the dynamics of the process can be quickly incorporated into the process model; at the same time, said process model, called in this case predictive adaptive model, is used to predict the evolution of the process output variables and to control the process. This is the case of the previously mentioned ADEX controllers in their adaptive predictive operating domains.

It is also known that the value of the parameters of a model capable of representing the dynamics of a process depends on the chosen control period. Consequently, for both model-based predictive controllers and ADEX controllers, the choice of the control period will determine the range of magnitude of the value of the predictive or adaptive predictive model parameters. It is known that the choice of the control period below a certain time threshold, called “modeling threshold”, which is relatively small with respect to the previously mentioned natural response time of the process under control, makes the value of a set of parameters of the predictive or adaptive predictive model is excessively close to zero in absolute value. This makes these parameters increase their sensitivity to any small identification error in their value and, therefore, the use of the value of these parameters in the prediction of the evolution of the output variable of the process under control and in the calculation of the control signal to be applied to the process can significantly deteriorate the performance of the controller.

A control scenario with control periods greater than said modeling threshold would prevent said set of predictive or adaptive predictive model parameters from undesirably approaching zero and reduce its sensitivity to small identification errors. However, in practice, the choice of these larger control periods may not be possible, as they would limit the precision and responsiveness of the control system to disturbances that the control signal could not counteract until the end of the period. of control. For example, the control period that is generally applied to establish changes in the clinker feed of a cement mill is generally close to 30 seconds, and the control period that is generally applied to establish changes in the coal flow rate of a power plant is approximately 1 minute. In both cases, the control period is below the modeling threshold. Therefore, the control performance of such advanced model-based controllers, adaptive or non-adaptive, is generally suboptimal with significant room for improvement under the control period required by practice.

It can also happen that, when the control period is below a certain modeling threshold, the model used by the advanced controller is of “reduced order”, that is, that the number of parameters of said model is not enough to identify complete process dynamics successfully, resulting in poor performance in the driver application. In this case, increasing the control period over said modeling threshold can make the number of model parameters used in the controller sufficient to achieve a satisfactory identification of the process dynamics and, as a result, better control performance. However, as explained above, choosing a control period below the modeling threshold can be mandatory and can significantly deteriorate control performance.

### BRIEF DESCRIPTION OF THE INVENTION

The ADEX system of the present invention uses a digital computer to apply a process control strategy in which an Adaptive Predictive Expert controller (ADEX) is used. This ADEX controller uses in its predictive adaptive domains a predictive adaptive model that dynamically relates the output of the process under control with an integral function of the control signal that is applied to the process. In this way, the output of said ADEX controller is not the control signal to be applied to the process as in the prior art state, but an integral function of the control signal to be applied to the process. From this integral function said control strategy uses a differential operator to calculate the real control action that is applied to the process.

Thus, the control procedure of the invention, for calculating the control signal at each instant k, is characterized by comprising the steps of:
1) Generate an integral function of the control signal that is applied to the process by executing the sequence of operations of an ADEX controller in one of its adaptive predictive domains, whose adaptive predictive model relates the output of the process with said integral function of the control signal, in order to drive the output of the process towards its set point.
2) Calculate a second integral function of the control signal to apply to the process up to time k−1.
3) Calculate the control signal to apply to the process using a differential operator that derives said control signal from the integral functions previously considered.
4) Apply said control signal to the apparatus that performs the process to control the evolution of its output variables.

For its part, the ADEX system that applies this procedure comprises a controller computer to generate the control signal that is applied at every instant k to the apparatus that performs the process, which is configured by sets of instructions and means to operate such as: a. An ADEX controller that operates in a predictive adaptive domain and whose adaptive predictive model dynamically relates the output of the process to be controlled with an integral function of the control signal to be applied to the process, so that the output of said ADEX controller is said integral function of the control signal and is calculated to guide said process output towards its set point; b. An integrator block that generates a second integral function of the control signal to be applied to the process up to time k−1; c. A differential block that calculates said control signal to be applied to the process from the two integral functions previously considered; d. Means that apply said control signal to the apparatus that performs the process to control the evolution of the output variables thereof.

### BRIEF DESCRIPTION OF THE DRAWINGS

For a better understanding of the invention, the following figures are included, which represent an exemplary embodiment and should not be considered more than a way to illustrate and clarify the invention.

FIG. 1 shows the general and conceptual structure of an ADEX system with integral control function according to one embodiment.

FIG. 2 shows a graph of trend curves for two consecutive periods of time. During an initial period of 6 minutes, the trend curves represent the result of a direct application of an ADEX controller with a control period below the modeling threshold to a simulated process. During a second period, after 6 minutes, the trend curves continue to represent the result of the direct application of the same ADEX controller to said simulated process, but in this second period the control period of this ADEX controller has been changed to a value above the modeling threshold. The trend curves in the upper part of the figure represent the evolution of the process output (thick line) and its set point (thin line), the scale for both curves is on the ordinate axis on the left side. The trend curve in the middle represents the control signal generated by the ADEX controller and applied to the process, the scale is on the ordinate on the right side. The trend curve at the bottom is only to indicate when the control period has changed.

FIG. 3 also shows a graph of trend curves for two consecutive time periods. The results presented in the initial period of 6 minutes are equivalent to those presented in the initial period of FIG. 2, that is, the result of a direct application of the same ADEX controller of FIG. 2 with a control period below the modeling threshold to the same simulated process. During the second period of 6 minutes, the control signal applied to the process is changed to that generated by an ADEX system with integral control function of the present invention and the control period remains the same as that used during the initial period. The trend curves have a meaning equivalent to those in FIG. 2.

### MODES OF EMBODIMENT OF THE INVENTION

An embodiment of the invention is briefly described below, as an illustrative and non-limiting example thereof.

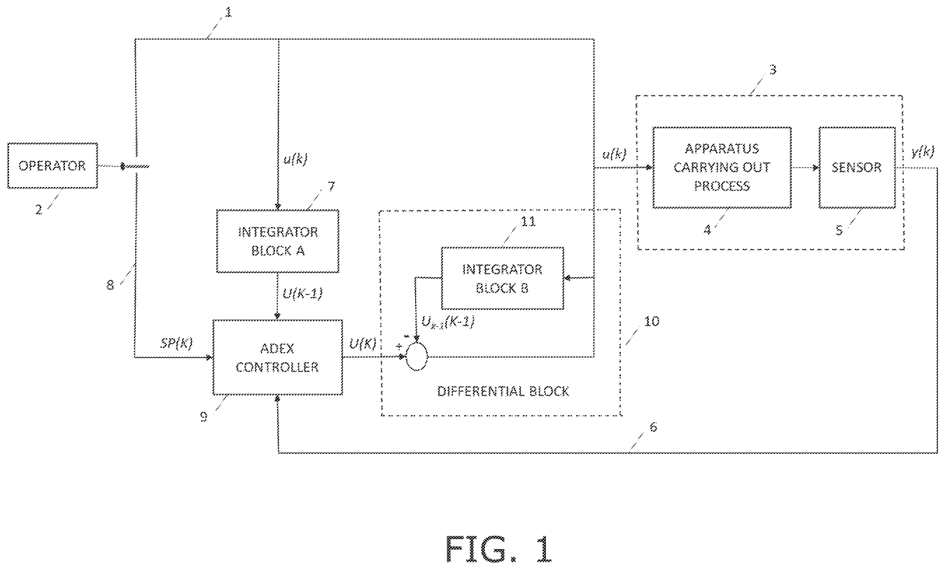

At any control instant k, the human operator can choose to apply manual control or automatic control to the process variable to be controlled; both forms of control are shown in FIG. 1 and are described with reference to said figure below:

1. Manual control: under manual control, the control signal u (k) is applied directly from the operator (2) to the apparatus (4) carrying out the process being controlled and to the integrator block A (7) as shown on the road (1). A sensor (5) associated with the apparatus (4) measures the process output variable y (k) to be controlled. This variable y (k) is applied as an output variable of the process to be controlled, as shown in path (6), to the ADEX controller (9). The integrator block A (7) calculates a control integral function in k−1, U (k−1), integrating said control signal u (k) between two previous control instants, k−δ and k−1, where δ is an integer that represents the integration interval in control periods, where δ≥2. Said integral control function at k−1, U (k−1), is applied as controller output at k−1 to the ADEX Controller (9). Therefore, under manual control, the ADEX Controller (9) receives as inputs: 1) said process output variable y (k), and 2) said integral control function in k−1, U (k−1). This allows the ADEX Controller (9) to operate in the identification mode for adaptive predictive domains (AP) described in U.S. Pat. No. 6,662,058 B1. Said identification mode will adjust the parameters of the adaptive predictive model (AP) for the corresponding operating domain of the ADEX controller (9), in such a way that said AP model will represent a dynamic relationship between said process output variable y (k) and said integral control function U (k−1) and, therefore, will be able to predict future values of said process output variable y (k) based on a future sequence of values of said integral control function U (k−1). Automatic control: under automatic control, the SP setpoint value (k) for the process output variable y (k) is applied directly from the operator (2) to the ADEX Controller (9), as shown in the path (8). Also, the measured process output variable y (k) is applied to the ADEX controller (9) from the sensor (5) as shown in path (6). This allows the ADEX Controller (9) to operate in the automatic mode for adaptive predictive domains (AP) described in U.S. Pat. No. 6,662,058 B1. In this automatic mode, from the process output variable y (k) and its SP (k) setpoint, the ADEX controller (9) generates as controller output an integral control function in k, U (k), which in this case represents the integration of said process control signal u (k) between two control instants, k+1−d and k. The output U (k) of the ADEX Controller (9) is applied to the Differential Block (10) that calculates the control signal u (k) that is applied to the process. The integrator block B (11) calculates a second integral function Uk−1 (k−1) integrating said control signal u (k) between the previous control instants, k+1−d and k−1. Said second integral function Uk−1 (k−1) is subtracted from said control integral function in k, U (k), within the differential block (10) to generate the control signal u (k) that is applied to the apparatus (4) that carries out the process being controlled. The specific operations that the ADEX System of this invention will carry out at each control instant k to automatically control the process output variable y (k) are described below:
(a) Measurement by the sensor (5) of the process output variable carried out by the apparatus (4) to obtain the process output variable y (k) to be controlled.
(b) Calculation of the integral control function in k, U (k), by the ADEX controller (9) as controller output. This controller calculates the integral control function U (k) from the value of the output of the process to be controlled, y (k), and the value of its setpoint in k, SP (K), applied directly from the operator (2) to the ADEX Controller (9), and executing the sequence of operations described in U.S. Pat. No. 6,662,058 B1 for ADEX controllers in predictive adaptive domains of operation.
(c) Calculation of said second integral function Uk−1 (k−1) by means of the equation that determines the operation of the integrator block B (11) within the differential block:
   where Uk−1 (k−1) is obtained integrating the previous control signals u (k) from time k−1 to time k+1−d, and δ≥2 is an integer conveniently selected by the ADEX system designer.
(d) Calculation of the control signal u (k) in the differential block by means of:
(e) Application of the control signal u (k) to the apparatus that performs the process.

In its implementation, the ADEX System of the present invention can be applied to a scalar process output variable, y (k), as previously considered, or to a process output vector, y (k), composed of n components of scalar output, which are n scalar process output variables. In this case, the ADEX system can be applied to each of said n scalar components of the process output vector, as described above, but taking into account the multivariate nature of the process, said ADEX controller can be a multivariable ADEX controller that guides said process output vector y (k) towards its setpoint vector SP (k). Said multivariable ADEX controller calculates as its output a vector integral function of control in k, U (k), which will be applied to a multivariable differential block in which an integrator block will calculate a second integral function vector Uk−1 (k−1) by means of:

where u (k−i) is the control vector that has been applied at times k−i to the apparatus that develops the process and the control vector u (k), which is applied to the apparatus that performs the process at time k, is calculated in said differential block by means of:

### EXAMPLE

The performance of the ADEX system with integral function of the control signal of the present invention will be illustrated by controlling a simulated mono-variable process, with one input, u (k), and one output, y (k), both at time k, which are measured as increments of their values when the process is in a state of equilibrium, considering that the process is in equilibrium when both input and output variables are equal to zero. When the control period is equal to 1 second, the dynamics of the simulated process can be described by the following equation: y(k)=y(k)+0.1u(k−1)+0.1u(k−2)+0.2u(k−3)+0.2u(k−4)(5) To illustrate the performance of the ADEX system of the invention, the simulated process will be controlled in the different scenarios described below:

In a first scenario, an ADEX controller operating in a predictive adaptive domain is used to control the simulated process, using the sequence of operations described in U.S. Pat. No. 6,662,058B1 and with a control period of 1 second and a prediction horizon of 5 control periods. The parameters of the driver block of the ADEX controller, which generates the desired path for the process output, are the same as those of a second order model with a time constant equal to 1, 5 control periods, a gain and a ratio of damping equal to 1, and the adaptive predictive model (AP), which relates the output of the process with the control signal, is of the first order with two parameters so that it calculates the a priori estimate of the output of the process at the instant by the equation:

As described in the previously cited patents, the ADEX controller adaptation mechanism will adjust the parameters of this model to make said a priori estimate of the process output converge towards the process output itself.

Using this same AP model, the prediction of the process output at time from the control signal u (k) applied at time k is given by:

The control signal u (k) generated by the ADEX controller at instant k will make the predicted output of the process at instant k equal to the desired output generated at instant k by the driver block for that same instant k+1, yd (k+lk). Therefore, equating said desired output to said predicted output in equation (7) and solving, u (k) will verify the following equation:

In a second scenario, an ADEX controller operating in a predictive adaptive domain is used to control the simulated process, with the sequence of operations of patent U.S. Pat. No. 6,662,058B1, which has the same configuration as the ADEX controller in the first scenario, except that the period control is equal to 2 seconds.

Finally, in a third scenario, an embodiment of the ADEX system with an integral function of the control signal is used to control the simulated process, which has been previously described to illustrate the invention, with a value of δ, which determines the horizon for the calculation of the integral function of the control signal, equal to 10, and an ADEX controller that has the same configuration as that of the ADEX controller considered in the first scenario, and a predictive adaptive model that, according to the invention, dynamically relates the process output with said integral function of the control signal U (k), so that in this case it calculates the a priori estimate of the process output at the time using the equation:

Using this same AP model, the output of the ADEX controller at instant k, U (k), will verify the following equation:

Where, analogously to equation (8), yd (k+lk) is the value of the desired path for the process output at control instant k+1.

The AP model described by equation (6), which estimates the output of the process y (k) and operates with a control period of 1 second, has a reduced order with respect to equation (5), which represents the dynamics of the process when the control period is also 1 second. For this control period of 1 second, the AP model of equation (6) does not have the adequate parametric structure to allow the adaptation mechanism of the ADEX controller to perform the identification of the dynamics of the process described by equation (5), because in equation (6) there are only 2 parameters and it would need to have 2 other parameters:

When the control period is equal to 2 seconds, the dynamics of the simulated process can be described by an equation of the same order as the AP model of equation (6), that is, with the same number of parameters. In this case, the adaptation mechanism of the ADEX controller will be able to successfully identify the dynamics of the process using the AP model described by equation (6).

Therefore, the 1 second control period is below the modeling threshold for an ADEX controller using the AP model in equation (6) and satisfactory control performance cannot be expected. However, if the control period is increased to 2 seconds, the same ADEX controller can achieve a good identification of the process dynamics and as a result, satisfactory control performance, that is, the control period of 2 seconds is above the modeling threshold. However, thanks to the invention it is possible to obtain a satisfactory control performance despite using a control period below the modeling threshold.

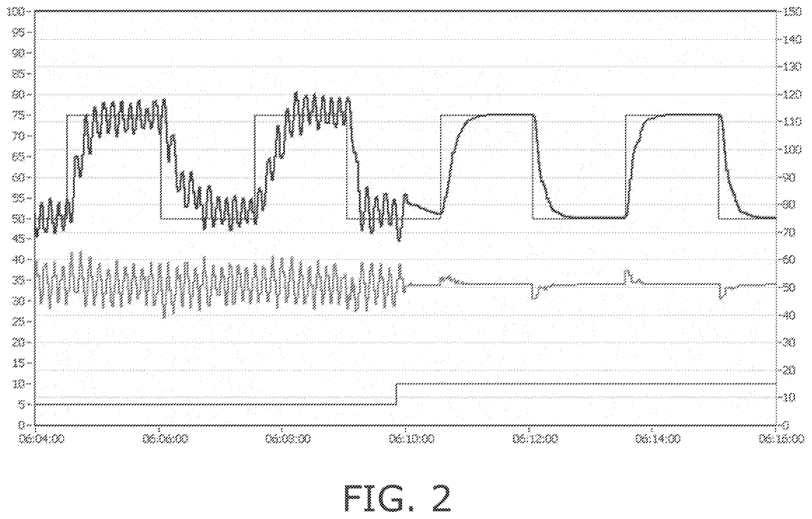

The evolution curves of FIG. 2 present the results obtained in the application of the ADEX controller, with a control period of 1 second described in the first scenario, to the simulated process during the first 6 minutes of the experiment. During the second 6 minutes, the results are shown the results obtained by the same ADEX controller when the control period is 2 seconds. The evolution curves in the upper part of the figure represent the process output evolution (thick line) and its set point (thin line); the scale is displayed on the left axis of the ordinate. The evolution curve in the lower part represents the control signal generated by the ADEX controller with control periods of 1 and 2 seconds and applied to the process, its scale is represented on the right ordinate axis. The curve in the base of the figure only indicates the instant at which the change in the control period occurs.

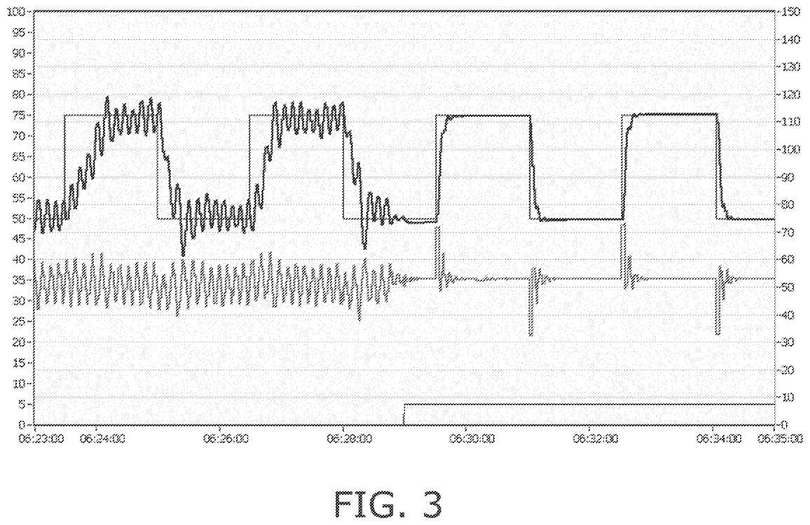

The evolution curves of FIG. 3 present the results obtained in the application of the ADEX controller, with a control period of 1 second, to the simulated process during the first 6 minutes of the experiment and, during the second 6 minutes, the results obtained when the control signal of said controller it is changed by the control signal to the process generated by the ADEX system with integral control function of the invention with a control period also of 1 second. The evolution curves and scales are equivalent to those described for FIG. 2.

The results presented in the first 6 minutes of FIG. 2 show how the conventional prior art application of an ADEX controller using a control period of 1 second, below the modeling threshold, does not achieve satisfactory control performance. That is, the output of the process under control oscillates with a great amplitude around its set point and the control signal also oscillates in a similar way, without any perspective for the process to approach stability. However, as shown by the results presented in the second 6 minutes of FIG. 2, when the same ADEX controller begins to use a control period of 2 seconds, above the modeling threshold, the process output stops oscillating and converges towards the set point following a desired output path. In addition, subsequent changes in the set point cause the process output to catch up with and stabilize therein following a desired output path as well, demonstrating satisfactory control performance. This desired path corresponds to the configuration of the driver block of the ADEX controller, which has been previously described.

The results presented in the second 6 minutes of FIG. 3 demonstrate that an ADEX system with integral control function can achieve satisfactory control performance using a control period of 1 second, below the modeling threshold of the conventional ADEX controller used in the first 6 minutes of this same figure. From the beginning, the process output follows a desired path to reach and stabilizes at the set point. This satisfactory control performance is reproduced in subsequent setpoint changes. Also in this case, this desired path corresponds to the configuration of the driver block of the ADEX controller, which has been previously described.

It can be seen that the desired trajectories converge towards the setpoint much faster when the process output is controlled with a control period of 1 second by the ADEX system with integral control function (FIG. 3), than when the process output is controlled by the conventional ADEX controller with a control period of 2 seconds (FIG. 2). The reason is that the driver block of an ADEX controller generates the desired trajectory depending on the control period, so that the shorter the control period, the faster the desired trajectory of the output of the process under control approaches its setpoint.

As illustrated in this simulation example, the use of ADEX systems with integral control function will allow satisfactory control performance to be obtained using control periods below the modeling thresholds of conventional ADEX controllers. The use of these “short” control periods is mandatory for a wide variety of industrial processes and therefore the use of ADEX systems with integral control function represents a significant advance in control performance for these types of industrial processes.

1. A procedure for generating a control vector u (k) during each of a plurality of control instants k, said control vector is applied to an apparatus that performs a process with at least one input variable and at least one output variable, at least one of said input variables defines a process input vector and at least one of said output variables defines a process output vector and (k), said apparatus varies said process input vector according to the value of said control vector, said method guides said process output vector towards a setpoint vector SP (k), said method characterized by comprising the following steps:
(A) generate an integral function vector U (k) of the control vector that is applied to the process u (k) by executing the sequence of operations of an ADEX controller in one of its adaptive predictive domains, whose adaptive predictive model relates the vector of process output y (k) with said vector integral function of the control vector, in order to drive the process output vector towards its SP (k) setpoint;
(B) calculate a second integral function vector Uk−1 (k−1) of the control vector to be applied to the process up to time k−1;
© calculating the control vector to be applied to the process u (k) using a differential operator that derives said control vector from the integral function vectors generated in the previous steps (A) and (B);
(D) apply said control vector to the apparatus that performs the process.

2. A method according to claim 1, characterized by carrying out steps (A) and (B) as follows:
(A) Generate a vector integral control function U (k), which represents an integral function of the values of said control vector u (k) between two control instants k+1−d and k, where d≥2, using a ADEX controller that operates in a predictive adaptive domain and whose predictive adaptive model dynamically relates the process output vector y (k) with said control integral function vector, so that the output of said ADEX controller is said vector U (k) and is calculated to guide said process output vector towards its setpoint vector SP (k);
(B) Generate a second integral function vector Uk−1 (k−1), by means of an integral function of the values of said control vector u (k) between the two previous control instants k+1−d and k−1.

3. An ADEX system comprising a controller computer to apply the method to generate a control vector u (k) of claim 1, during each of a plurality of control instants k, said control vector is applied to an apparatus that carries out a process with at least one input variable and at least one output variable, at least one of said input variables defines a process input vector and at least one of said output variables defines a vector output process y (k), said apparatus varies said process input vector according to the value of said control vector u (k), said system guides said output vector y (k) towards a setpoint vector SP (k), said controlling computer is configured by sets of instructions to operate as:
a. An ADEX controller that operates in a predictive adaptive domain and whose predictive adaptive model dynamically relates the output vector of the process y (k) with an integral function vector U (k) of the control vector that is applied to the process, so that the output of said ADEX controller is said vector U (k) and is calculated to guide said process output vector towards its setpoint vector SP (k);
b. An integrator block that acts by generating a second integral function vector Uk−1 (k−1) of the control vector to be applied to the process until time k−1. C. A differential block that derives said control vector u (k) from the integral function vectors generated by said ADEX controller and said integrator block. Wherein said control vector u (k) is applied to said apparatus such that said apparatus varies said process input vector in accordance with said control vector.

4. An ADEX system according to claim 3, characterized by configuring the instruction sets a and b as follows:
a: An ADEX controller that operates in a predictive adaptive domain and whose predictive adaptive model dynamically relates the output vector of the process y (k) with a vector integral control function U (k), which represents an integral function of the values of said vector of control u (k) between two control instants k+1−dyk, where d≥2, so that the output of said ADEX controller is said vector U (k) and is calculated to guide said process output vector towards its setpoint vector SP (k);
b. An integrator block that acts by generating a second integral function vector Uk−1 (k−1), which is an integral function of the values of said control vector u (k) between the two control instants k+1−5 and k−1.

5. An ADEX system comprising a controller computer to apply the method to generate a control vector u (k) of claim 2, during each of a plurality of control instants k, said control vector is applied to an apparatus that carries out a process with at least one input variable and at least one output variable, at least one of said input variables defines a process input vector and at least one of said output variables defines a vector output process y (k), said apparatus varies said process input vector according to the value of said control vector u (k), said system guides said output vector y (k) towards a setpoint vector SP (k), said controlling computer is configured by sets of instructions to operate as:
a. An ADEX controller that operates in a predictive adaptive domain and whose predictive adaptive model dynamically relates the output vector of the process y (k) with an integral function vector U (k) of the control vector that is applied to the process, so that the output of said ADEX controller is said vector U (k) and is calculated to guide said process output vector towards its setpoint vector SP (k);
b. An integrator block that acts by generating a second integral function vector Uk−1 (k−1) of the control vector to be applied to the process until time k−1. C. A differential block that derives said control vector u (k) from the integral function vectors generated by said ADEX controller and said integrator block. Wherein said control vector u (k) is applied to said apparatus such that said apparatus varies said process input vector in accordance with said control vector.

6. An ADEX system according to claim 5, characterized by configuring the instruction sets a and b as follows:
a: An ADEX controller that operates in a predictive adaptive domain and whose predictive adaptive model dynamically relates the output vector of the process y (k) with a vector integral control function U (k), which represents an integral function of the values of said vector of control u (k) between two control instants k+1−dyk, where d≥2, so that the output of said ADEX controller is said vector U (k) and is calculated to guide said process output vector towards its setpoint vector SP (k);
b. An integrator block that acts by generating a second integral function vector Uk−1 (k−1), which is an integral function of the values of said control vector u (k) between the two control instants k+1−5 and k−1.
